(19) United States
(12) Patent Application Publication
(10) Pub. No.: US 2010/0174622 A1
(43) Pub. Date: Jul. 8, 2010

(54) System for searching for sound source using map information and method thereof

(75) Inventors: Dong-Jin Sohn, Seongnam-si (KR); Sung-Jae Cho, Seoul (KR); Hyung-Bo Sim, Gwangmyeong-si (KR); Hwa-Young Song, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,395

(22) Filed: Dec. 30, 2009

(30) Foreign Application Priority Data
Dec. 31, 2008 (KR) 10-2008-0138175

(51) Int. Cl. G06Q 30/00; G06F 15/16; G06F 3/048

(52) U.S. Cl. 705/27; 709/203; 715/716

(57) ABSTRACT

A sound source search system is capable of searching for a sound source using map information. If particular area information among the map information is selected, a sound source search client requests sound source tag information and sound source information associated with the selected particular area information. A sound source search server delivers the sound source tag information and the sound source information to the sound source search client in response to the request. The sound source search client displays one or more sound source tags corresponding to the particular area information on a screen based on the sound source tag information and sound source information received from the sound source search server.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Dec. 31, 2008 and assigned Serial No. 10-2008-0138175, the entire disclosure of which is hereby incorporated by reference.

### TECHNICAL FIELD OF THE INVENTION

The present invention relates generally to a system for searching for a sound source and a method thereof, and more particularly, to a system for searching for music using map information and a method thereof.

### BACKGROUND OF THE INVENTION

Generally, a user gets a sound source list from a sound source provider such as a sound source providing site in order to search for a sound source to which he/she desires to listen.

More specifically, in order to search for a sound source to which he/she desires to listen, the user sends a search request for the sound source to the sound source provider using sound source-related information such as a title of the sound source and a singer of the sound source. In response to the request, the sound source provider provides a sound source list associated with information regarding the requested sound source to the user.

The user may select a sound source he/she desires to listen to from the provided sound source list, and then listen to or purchase the selected sound source.

If the provided sound source list includes no sound source the user desires to listen to, the user may search for a sound source he/she desires to listen to, using the sound source title search or the sound source category search.

Besides, the user may directly listen to a sound source using a sample sound source streaming service randomly provided from the sound source provider, and then search for or purchase the sound source.

As described above, in the conventional sound source search, the user uses a sound source list provided from the sound source provider for sound source search, or directly searches for a sound source.

In this sound source search, in order to search for a new sound source, the user is required to know a title of the sound source.

### SUMMARY OF THE INVENTION

To address the above-discussed deficiencies of the prior art, it is a primary object to provide at least the advantages described below. Accordingly, an aspect of the present invention provides a system and method for searching for a sound source using map information.

In accordance with one aspect of the present invention, there is provided a system for searching for a sound source using map information, in which a sound source search client requests sound source tag information and sound source information associated with particular area information if the particular area information among the map information is selected; and a sound source search server delivers the sound source tag information and the sound source information to the sound source search client. The sound source search client displays one or more sound source tags corresponding to the particular area information on a screen based on the sound source tag information and sound source information received from the sound source search server.

In accordance with another aspect of the present invention, there is provided a method for searching for a sound source using map information in a sound source search system including a sound source search client and a sound source search server, in which if particular area information among the map information is selected, the sound source search client requests sound source tag information and sound source information associated with the selected particular area information. The sound source search server delivers the sound source tag information and the sound source information to the sound source search client in response to the request. The sound source search client displays one or more sound source tags corresponding to the particular area information on a screen based on the sound source tag information and sound source information received from the sound source search server.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram showing a configuration of a sound source search system according to an embodiment of the present invention;

FIG. 2 illustrates a diagram showing a structure of a sound source search client according to an embodiment of the present invention;

FIG. 3 illustrates a diagram showing structures of sound source tag information and sound source information according to an embodiment of the present invention;

FIG. 4 illustrates a flow diagram showing a process of searching for and purchasing a sound source in a sound source search system according to an embodiment of the present invention;

FIG. 5 illustrates a diagram showing a method of composing a screen using sound source tag information and sound source information in a sound source search client according to an embodiment of the present invention;

FIG. 6 illustrates a diagram showing a sound source tag indication screen composed according to an embodiment of the present invention; and

FIG. 7 illustrates a diagram showing a detailed-sound source information screen composed according to an embodiment of the present invention.

Throughout the drawings, the same drawing reference numerals will be understood to refer to the same elements, features and structures.

### DETAILED DESCRIPTION OF THE INVENTION

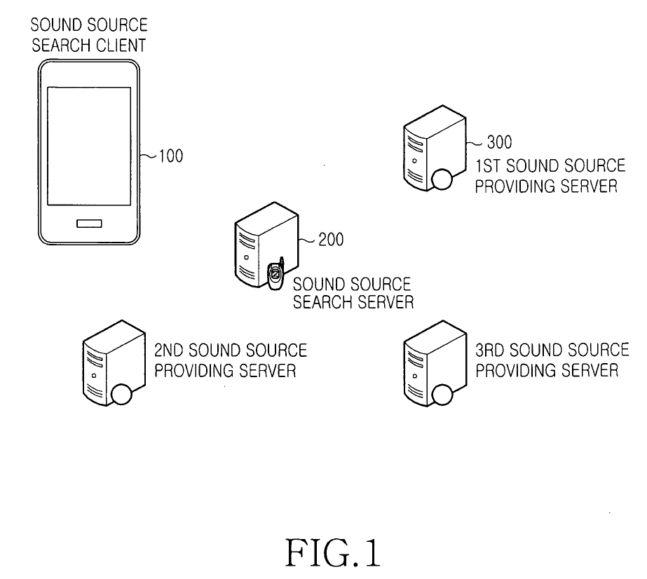

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

FIG. 1 illustrates a configuration of a sound source search system according to an embodiment of the present invention.

The sound source (or music) search system according to an embodiment of the present invention includes a sound source search client 100, a sound source search server 200, and one or more sound source providing servers 300.

With reference to FIG. 1, a description will be made of a process of searching for a sound source upon a user's request and purchasing the searched sound source in a sound source search system according to an embodiment of the present invention.

Upon a request for a map information-based sound source search service, the sound source search client 100 sends a request for map information to the sound source search server 200.

In response, the sound source search server 200 delivers the requested map information to the sound source search client 100.

If a particular area is selected by the user, the sound source search client 100 sends a request for sound source tag information and sound source information corresponding to the selected area to the sound source search server 200.

In reply to the request, the sound source search server 200 delivers a sound source tag list consisting of one or more sound source tag information corresponding to the particular area, and its associated sound source information, to the sound source search client 100.

With use of the received sound source tag list, the sound source search client 100 displays on a screen a sound source tag to which one or more sound source tag information is matched in the particular area.

If any one of sound source tags indicated in a particular area is selected, the sound source search client 100 displays a screen indicating detailed sound source information for the selected sound source tag. That is, the sound source search client 100 may display a pop-up window with the detailed sound source information in a location where the sound source tag is indicated. The detailed sound source information may include information about sound source prices, sound source producers, music companies, and the like.

If a purchase request for a sound source associated with the indicated detailed sound source information is received from the user, the sound source search client 100 sends a request for sound source purchase to the sound source search server 200.

In reply to the request, the sound source search server 200 sends a request for sound source purchase to the first sound source providing server 300.

In response, the first sound source providing server 300 delivers the purchase-requested sound source to the sound source search client 100. In other cases, the first sound source providing server 300 may directly receive a request for sound source purchase from the sound source search client 100, and provide the requested sound source to the sound source search client 100.

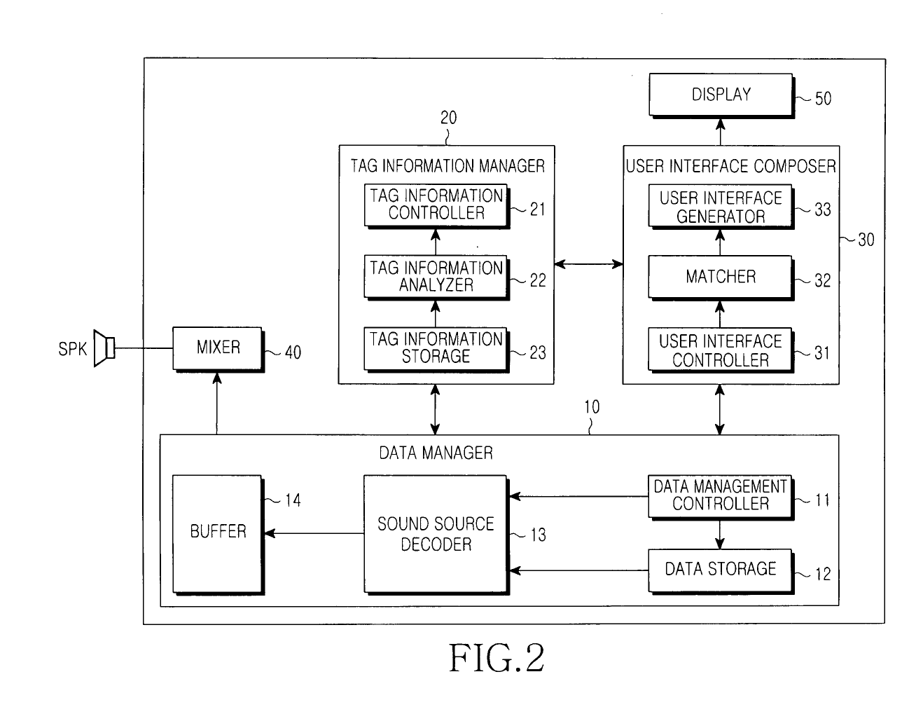

FIG. 2 illustrates a structure of a sound source search client according to an embodiment of the present invention.

The sound source search client 100 according to an embodiment of the present invention includes a data manager 10, a tag information manager 20, a user interface composer 30, a mixer 40, and a display 50.

The data manager 10 includes a data management controller 11, a data storage 12, a sound source decoder 13, and a buffer 14.

Upon a user's request, the data management controller 11 sends a request for map information for sound source search to the sound source search server 200.

Upon receiving the requested map information, the data management controller 11 stores the received map information in the data storage 12, and displays the associated status on the display 50.

Upon a user's request, the data management controller 11 sends a request for sound source tag information of a particular area to the sound source search server 200.

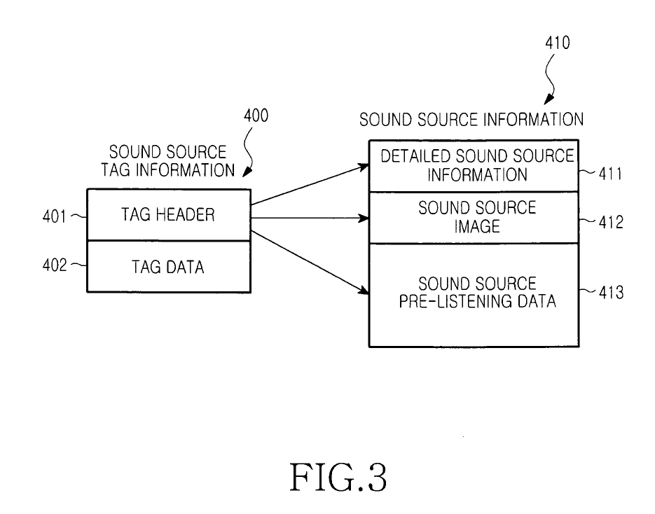

The data management controller 11 receives sound source tag information and sound source information of a particular area from the sound source search server 200 upon a request. The data management controller 11 receives a sound source tag information header first among the sound source tag information and sound source information. The sound source tag means a keyword associated with a particular sound source, and the sound source tag information includes information about a location of a sound source tag located in a particular area and comments such as user's feeling and thought associated with the sound source. The sound source information includes detailed sound source information, a sound source image, and sound source pre-listening data. The sound source tag information and sound source information will be described with reference to FIG. 3.

Referring to FIG. 3, sound source tag information 400 includes a tag header 401 and tag data 402.

The tag header 401 means indication information indicating a location of a sound source tag existing in a particular area. The tag data 402 means comments that the user has updated his/her feeling or thought with regard to a sound source corresponding to a sound source tag existing in a particular area.

Sound source information 410 includes detailed sound source information 411, a sound source image 412, and sound source pre-listening data 413.

The detailed sound source information 411 means information about sound source prices, sound source producers, music companies, and the like.

The sound source image 412 means a sound source-related image such as album (or music) jacket images.

The sound source pre-listening data 413 means sound source data corresponding to a partial play time among the entire sound source data.

With use of the sound source tag information and sound source information, the sound source search client 100 may display one or more sound source tags corresponding to a particular area on the screen.

Since the present invention can receive and process data within the limited network bandwidth, if sound source tag information of a particular area is simultaneously received, overflow may occur. Therefore, the present invention may receive only the header information first among the sound source tag information and indicate the existence of a sound source tag existing in a particular area.

Further, the data management controller 11 stores the received sound source tag header information in the data storage 12 and delivers the stored sound source tag header information to the tag information manager 20.

The data management controller 11 receives a sound source image and sound source pre-listening data next among sound source information of a particular area from the sound source search server 200. For example, the data management controller 11 may receive the sound source pre-listening data first, or may receive the sound source image first. That is, the data management controller 11 first delivers the first received sound source tag information to the tag information manager 20.

The data management controller 11 stores the received sound source image and sound source pre-listening data in the data storage 12, and delivers the stored sound source image to the user interface composer 30.

Finally, the data management controller 11 receives detailed sound source information and tag data from the sound source search server 200, and stores the received detailed sound source information and tag data in the data storage 12.

The data management controller 11 delivers sound source pre-listening data among the sound source tag information analyzed in the tag information manager 20 to the sound source decoder 13, and controls the sound source decoder 13 to decode the sound source pre-listening data.

The data management controller 11 stores sound source pre-listening data decoded by the sound source decoder 13 in the buffer 14.

The data management controller 11 mixes the sound source pre-listening data stored in the buffer 14 by means of the mixer 40, and then outputs the mixed data through a speaker SPK. Accordingly, the present invention outputs one or more sound source pre-listening data corresponding to a particular area, so the user may previously listen to a sound source corresponding to sound source tag information while checking the sound source tag information of the particular area. Besides, the data management controller 11 may set a volume at an area selected by the user to be greater than a volume of sound source pre-listening data corresponding to other areas, so the user may previously listen to sound sources of different volumes in different locations.

If any one of sound source tags indicated at a user's request is selected, the data management controller 11 reads detailed sound source information and tag data corresponding to the selected sound source tag from the data storage 12, and delivers the read data to a user interface controller 31.

Upon a request for purchasing a sound source associated with the sound source tag, the data management controller 11 sends a request for sound source purchase to the sound source search server 200. Upon a user information request for user authentication by the purchase request, the data management controller 11 receives user information necessary for the purchase and delivers the received user information to the sound source search server 200.

The data storage 12 stores map information, sound source tag information and sound source information received from the sound source search server 200.

The sound source decoder 13 decodes received sound source pre-listening data.

The buffer 14 temporarily stores the decoded sound source pre-listening data.

Meanwhile, the tag information manager 20 includes a tag information controller 21, a tag information analyzer 22, and a tag information storage 23.

The tag information controller 21 controls the tag information analyzer 22 to analyze a sound source tag information header received from the data manager 10 and to check indication information indicating locations of one or more sound source tags existing in a particular area. The tag information controller 21 stores the checked indication information in the tag information storage 23, and delivers the stored indication information to the user interface composer 30.

The tag information controller 21 controls the tag information analyzer 21 to analyze a tag header or tag data in the sound source tag information received from the data manager 10, and stores indication information of the analyzed tag header or user comment information of the tag data in the tag information storage 23.

The tag information controller 21 delivers sound source pre-listening data among the analyzed sound source tag information to the data manager 10, and delivers sound source titles and sound source images to the user interface composer 30.

The tag information analyzer 22 analyzes a tag header of the sound source tag information and checks indication information. Further, the tag information analyzer 22 analyzes tag data of the sound source tag information and checks the analyzed user comment information.

The tag information storage 23 stores the indication information of the tag header or the user comment information of the tag data.

Meanwhile, the user interface composer 30 includes a user interface controller 31, a matcher 32, and a user interface generator 33.

The user interface controller 31 receives map information from the data manager 10, and controls the user interface generator 33 to compose a map information screen including the received map information. The user interface controller 31 delivers the generated map information screen to the display 50.

Based on the received indication information, the user interface controller 31 controls the matcher 32 to match an indicator indicating a sound source tag located in a particular area of the map information, to the map information. The user interface controller 31 controls the user interface generator 33 to compose a screen using the indicator-matched map information. Thereafter, the user interface controller 31 delivers the composed screen to the display 50.

The user interface controller 31 controls the matcher 32 to match the indicator-matched map information with the received sound source image, and controls the user interface generator 33 to compose a screen using the matched image-map information. Thereafter, the user interface controller 31 delivers the composed screen to the display 50.

The user interface controller 31 controls the user interface generator 33 to compose a detailed-sound source information screen using the detailed sound source information, the tag data and the sound source image, and delivers the generated detailed-sound source information screen to the display 50.

The matcher 32 matches an indicator to the place where a sound source tag of a particular area in the map information is located. The matcher 32 also matches a sound source image associated with a relevant indicator to a particular area to which the indicator is matched.

The user interface generator 33 composes a map screen using the map information. The user interface generator 33 also composes a map screen including a particular area to which an indicator is matched, or composes a map screen including a sound source image matched to the composed map screen. Further, the user interface generator 33 composes a detailed-sound source information screen using the detailed sound source information, the tag data and the sound source image.

The mixer 40, which is a 3^{rd} dimension (3D) sound mixer, mixes input sound source data into 3D sound data.

The display 50 displays the screen composed by the user interface generator 33.

In this manner, the user may search for a sound source using a sound source tag indicated in a particular area of map information selected by the user.

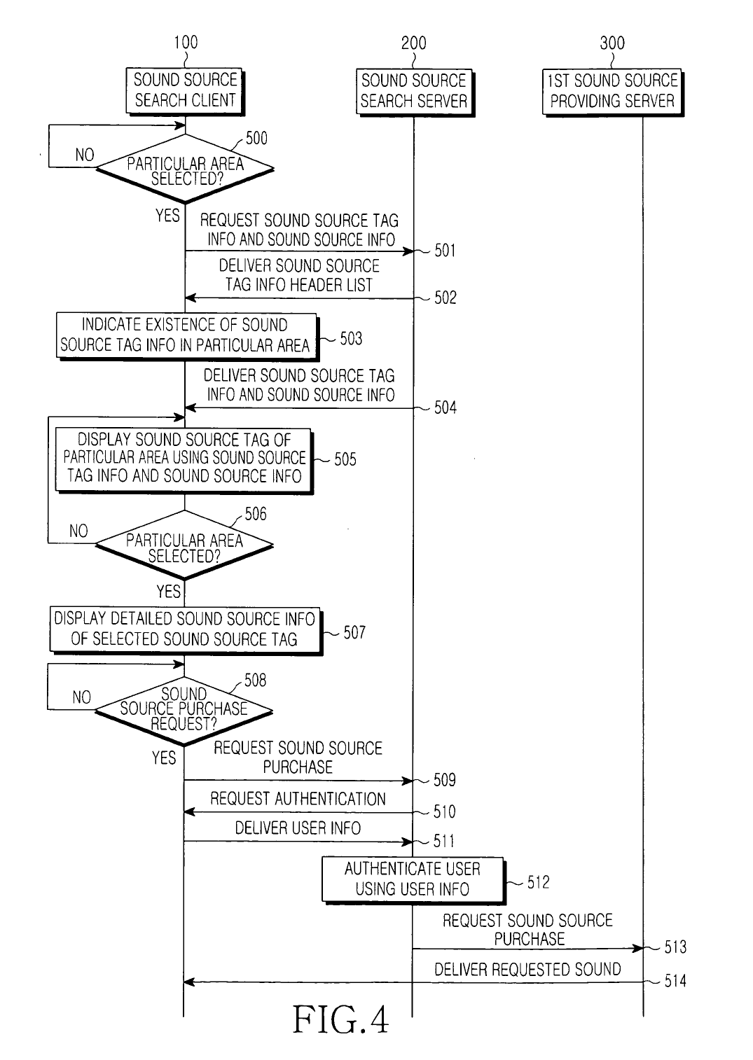

FIG. 4 illustrates a process of searching for and purchasing a sound source in a sound source search system according to an embodiment of the present invention.

In step 500, the sound source search client 100 determines whether a particular area in map information displayed at a user's request is selected. If a particular area is selected, the sound source search client 100 proceeds to step 501. Otherwise, the sound source search client 100 continuously determines in step 500 whether a particular area is selected.

In step 501, the sound source search client sends a request for sound source tag information and sound source information associated with the particular area to the sound source search server 200.

In step 502, the sound source search server 200 first sends a tag header list including a tag header among one or more sound source tag information associated with the particular area to the sound source search client 100 in response to the request.

In step 503, the sound source search client 100 displays the received tag header list on a screen on which an indicator is matched to a location where one or more tag information corresponding to the particular area is indicated.

In step 504, the sound source search server 200 delivers a sound source image and sound source pre-listening data among the sound source information to the sound source search client 100.

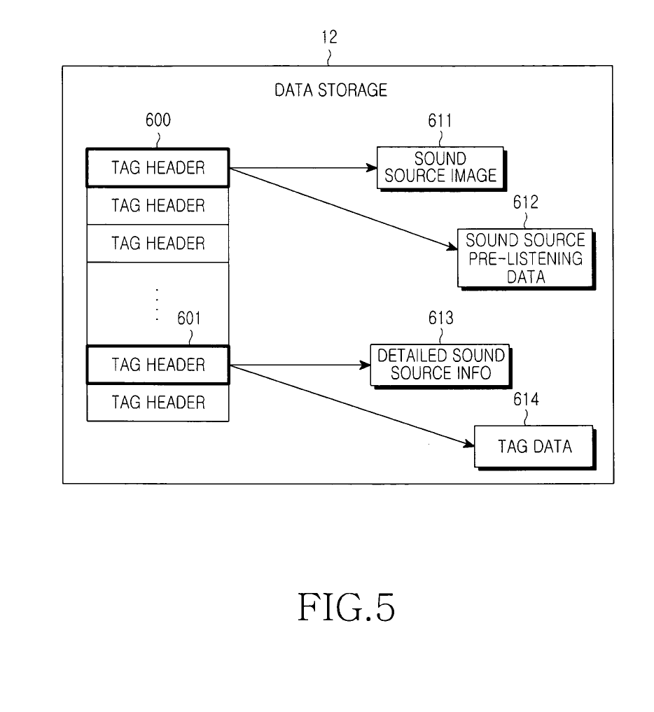

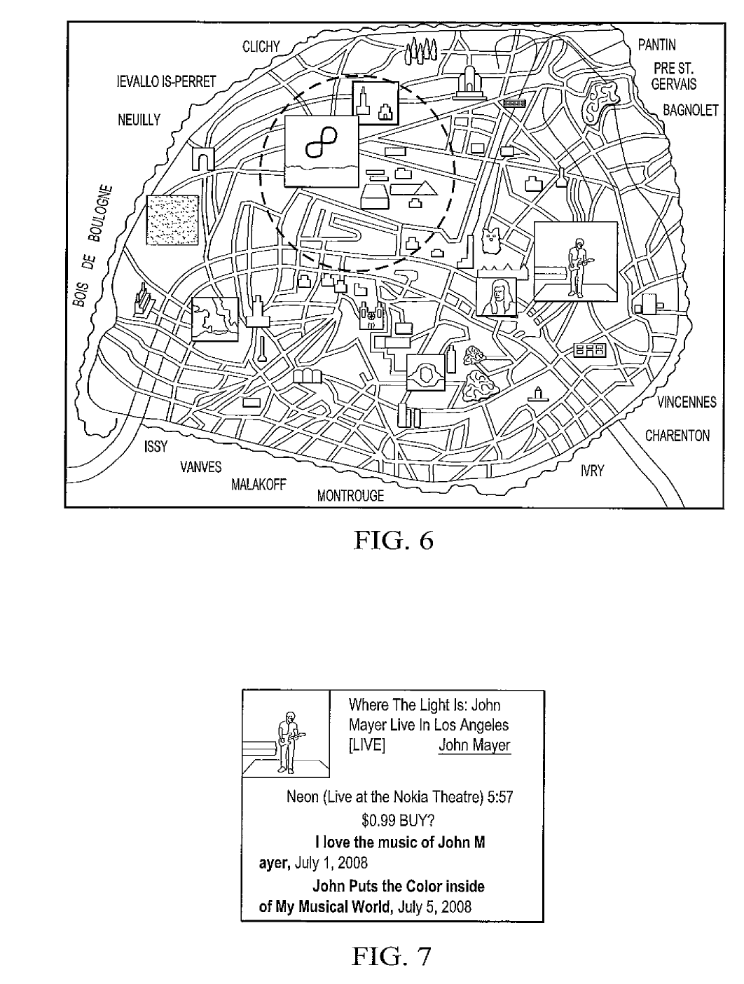

In step 505, the sound source search client 100 matches the received sound source image to a relevant location instead of the indicator indicated in the particular area, and displays the matching results. The sound source search client 100 decodes and mixes sound source pre-listening data associated with one or more tag information corresponding to the particular area, and outputs the mixing results through a speaker. Referring to FIG. 5, the sound source search client 100 a uses sound source image 611 and sound source pre-listening data 612, which are stored in the data storage 12 in association with a sound source tag header 600 corresponding to any one of particular areas. A screen composed in this way is as shown in FIG. 6.

In step 506, the sound source search client 100 determines whether any one of sound source tags displayed on the screen is selected. If any one of sound source tags is selected, the sound source search client 100 proceeds to step 507. Otherwise, the sound source search client 100 continuously outputs the sound source pre-listening data while displaying the screen indicating the sound source image matched to the particular area in step 505.

In step 507, the sound source search client 100 displays a detailed-sound source information screen that is composed using the received sound source tag information and sound source information. That is, the sound source search client 100 composes a detailed-sound source information screen using detailed sound source information 613, sound source image 611 and tag data 614 corresponding to a tag header 601 associated with the selected sound source tag, and displays the composed detailed-sound source information screen. The composed detailed-sound source information screen is as shown in FIG. 7.

In step 508, the sound source search client 100 determines whether there is a sound source purchase request. If there is a sound source purchase request, the sound source search client 100 proceeds to step 509. Otherwise, the sound source search client 100 continuously determines in step 508 whether there is a sound source purchase request.

In step 509, the sound source search client 100 sends a request for sound source purchase to the sound source search server 200.

In step 510, the sound source search server 200 sends a request for user authentication to the sound source search client 100.

In step 511, the sound source search client 100 delivers user information for the user authentication to the sound source search server 200.

In step 512, the sound source search server 200 performs user authentication using the received user information.

After completion of the user authentication, the sound source search server 200 sends a request for sound source purchase to the first sound source providing server 300 in step 513.

In step 514, the first sound source providing server 300 delivers the requested sound source to the sound source search client 100 that requested the sound source purchase.

As is apparent from the foregoing description, the present invention displays sound source-related information using map information and the user searches for or purchases a sound source he/she desires to listen to, based on the sound source-related information displayed in association with the map information, thereby making it possible to provide the user with information for searching for or purchasing music more instinctively.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A system capable of searching for a sound source using map information, the system comprising:
a sound source search client configured to request sound source tag information and sound source information associated with particular area information if the particular area information among the map information is selected; and
a sound source search server configured to deliver the sound source tag information and the sound source information to the sound source search client;
wherein the sound source search client is configured to display one or more sound source tags corresponding to the particular area information on a screen based on the sound source tag information and sound source information received from the sound source search server.

2. The system of claim 1, wherein the sound source tag information includes a sound source tag header indicating location information of a sound source tag corresponding to the particular area and sound source tag data including user comment information related to a sound source of the sound source tag.

3. The system of claim 2, wherein the sound source information includes detailed information about the sound source of the sound source tag, an image for the sound source, and pre-listening data for the sound source.

4. The system of claim 3, wherein the sound source search server sequentially delivers the sound source tag header, the image for the sound source, the pre-listening data for the sound source, the sound source tag data, and the detailed information about the sound source among the sound source tag information and sound source information, to the sound source search client.

5. The system of claim 1, further comprising a sound source providing server configured to provide a sound source upon a sound source purchase request;
wherein the sound source search client is configured to sends a request for sound source purchase to the sound source search server upon receiving a sound source purchase request from a user, the sound source search server sends a request for the sound source purchase to the sound source providing server upon the request, and the sound source providing server provides the purchase-requested sound source to the sound source search client.

6. A method for searching for a sound source using map information in a sound source search system including a sound source search client and a sound source search server, the method comprising:
requesting sound source tag information and sound source information associated with the selected particular area information by the sound source search client if particular area information among the map information is selected;
delivering, by the sound source search server, the sound source tag information and the sound source information to the sound source search client in response to the request; and
displaying, by the sound source search client, one or more sound source tags corresponding to the particular area information on a screen based on the sound source tag information and sound source information received from the sound source search server.

7. The method of claim 6, wherein the sound source tag information includes a sound source tag header indicating location information of a sound source tag corresponding to the particular area and sound source tag data including user comment information related to a sound source of the sound source tag.

8. The method of claim 7, wherein the sound source information includes detailed information about the sound source of the sound source tag, an image for the sound source, and pre-listening data for the sound source.

9. The method of claim 8, wherein delivering comprises sequentially delivering, by the sound source search server, the sound source tag header, the image for the sound source, the pre-listening data for the sound source, the sound source tag data, and the detailed information about the sound source among the sound source tag information and sound source information, to the sound source search client.

10. The method of claim 8, wherein displaying comprises:
analyzing, by the sound source search client, the sound source tag header received from the sound source search server and checking location information of a sound source tag located in the particular area;
composing a user interface screen on which an indicator indicating the checked location information is matched to map information for the particular area and displaying the user interface screen on the screen; and
displaying the image for the sound source in the indicator-matched particular area on the screen as the sound source tag.

11. The method of claim 10, further comprising decoding pre-listening data for a sound source received from the sound source search server and mixing the decoded pre-listening data.

12. The method of claim 10, wherein displaying comprises, if a particular tag is selected by a user, composing and displaying a detailed-sound source information screen including a sound source image, detailed sound source information and sound source tag data associated with the selected particular tag.

13. The method of claim 6, further comprising:
sending a request for sound source purchase to the sound source search server by the sound source search client upon receiving a sound source purchase request from a user;
sending, by the sound source search server, a request for the sound source purchase to a sound source providing server providing sound sources, in response to the request; and
providing the purchase-requested sound source to the sound source search client by the sound source providing server.

14. A sound source search client for use in a system capable of searching for a sound source using map information, the sound source search client configured to request sound source tag information and sound source information associated with particular area information if the particular area information among the map information is selected, wherein the sound source client is configured to receive the sound source tag information and the sound source information from a sound source search server configured, and wherein the sound source search client is configured to display one or more sound source tags corresponding to the particular area information on a screen based on the sound source tag information and sound source information received from the sound source search server.

15. The sound source search client of claim 14, wherein the sound source tag information includes a sound source tag header indicating location information of a sound source tag corresponding to the particular area and sound source tag data including user comment information related to a sound source of the sound source tag.

16. The sound source search client of claim 15, wherein the sound source information includes detailed information about the sound source of the sound source tag, an image for the sound source, and pre-listening data for the sound source.

17. The sound source search client of claim 16, wherein the sound source search client sequentially receives the sound source tag header, the image for the sound source, the pre-listening data for the sound source, the sound source tag data, and the detailed information about the sound source among the sound source tag information and sound source information, to the sound source search client.

18. The sound source search client of claim 17, wherein the sound source search client comprises:
a tag information manager configured to analyze the sound source tag header received from the sound source search server and checking location information of a sound source tag located in the particular area; and
a user interface composer configured to compose a user interface screen on which an indicator indicating the checked location information is matched to map information for the particular area;
wherein the user interface composer is configured to display the image for the sound source in the indicator-matched particular area on the screen as the sound source tag.

19. The sound source search client of claim 18, wherein the sound source search client further comprises a data manager configured to decode pre-listening data for a sound source received from the sound source search server and mixing the decoded pre-listening data.

20. The sound source search client of claim 18, wherein if a particular tag is selected by a user, the user interface composer composes and displays a detailed-sound source information screen including a sound source image, detailed sound source information and sound source tag data associated with the selected particular tag.
